(19) United States
(12) Patent Application Publication
(10) Pub. No.: US 2013/0097053 A1
(43) Pub. Date: Apr. 18, 2013

(54) METHOD AND SYSTEM FOR RECOMMENDING A COMBINED SERVICE BY TAKING INTO ACCOUNT SITUATION INFORMATION ON A TARGET USER AND THE DEGREE OF COMPLEMENTARITY OF A SERVICE

(71) Applicants: Nam Yeon Lee, Gunpo-si (KR); Oh Byung Kwon, Seongnam-si (KR)

(72) Inventors: Nam Yeon Lee, Gunpo-si (KR); Oh Byung Kwon, Seongnam-si (KR)

(73) Assignee: UNIVERSITY-INDUSTRY COOPERATION GROUP OF KYUNG- HEE UNIVERSITY, Yongin-si Gyeonggi-Do (KR)

(21) Appl. No.: 13/807,966

(22) PCT Filed: Sep. 20, 2011
(86) PCT No.: PCT/KR2011/006951

§ 371 Date: Jan. 2, 2013

(30) Foreign Application Priority Data
Mar. 18, 2011 (KR) 10-2011-0024497

(51) Int. Cl. G06Q 30/06

(52) U.S. Cl. CPC G06Q 30/0631
USPC 705/26.7

(57) ABSTRACT

The present invention relates to a method for recommending a service in a ubiquitous environment in which various services are provided, and more particularly, to a method and system for determining a service required for a user based on situation information of a target user, and recommending, to the target user, an individual service satisfying a service index of the target user with respect to the determined service, or a combined and highly complementary service.

### TECHNICAL FIELD

The present invention relates to a method of recommending a service in a ubiquitous computing environment in which various services are provided, and more particularly, to a method and system for determining a service required for a target user based on situation information of the target user, and recommending, to the target user, an individual service satisfying a service index of the target user with respect to the determined service or a highly complementary combined service.

### BACKGROUND ART

Ubiquitous computing is a compound word of ‘ubiquitous’ of a Latin word meaning widely existing whenever and everywhere and ‘computing’, which refers to an environment that enables computing with any kind of device regardless of time and space. Next-generation information devices presently represented by personal digital assistants (PDAs), Internet TVs, smart phones and the like are used as systems capable of processing information regardless of time and space, which are post-PC products having both portability and convenience. Specialized works are processed through the next-generation information devices, or the next-generation information devices can be connected to the Internet through a wireless communication network to process information, and it is expected that the ubiquitous computing will be gradually extended along with advancement in the related techniques and products.

A variety of services developed in the ubiquitous computing environment are provided to a user in the form of an individual service or a plurality of combined services, according to information on current situation of a user. With regard to this, studies on techniques for recognizing current situation of a user and techniques for recommending a service suitable for the recognized current situation of the user are actively in progress.

In the past, studies are focused on the techniques for recommending only one individual service suitable for a recognized user situation. However, recently, studies on the techniques for combining a plurality of services suitable for a recognized user situation and recommending the combined services to the user are in progress. The method of recommending the combined services corresponding to the recognized user situation is largely divided into a static combined service recommendation method and a dynamic combined service recommendation method.

First, the static combined service recommendation method is also referred to as a proactive combination method, in which a service provider determines combined services in advance and provides a user with a predetermined combined service. Accordingly, such a conventional static combined service recommendation method entails a problem in that since it provides the user with only the service combinations determined in advance, it is difficult to recommend a service combination suitable for a user depending on a user situation varying in real-time and it is difficult to reflect preference of a user when recommending a service combination.

In order to solve the problems involved in the static combined service recommendation method, a dynamic combined service recommendation method proposed is which considers information on a situation of a user varying in real-time and reflects preference of the user when recommending a service combination. The conventional method of dynamically recommending a combined service simply combines individual services used by the other users in a situation similar to that of a user based on the user situation information and recommends the combined services to the user. However, although such a combined service recommendation method which simply combines individual services may recommend a service combination to a user in a speedy way, it does not consider relationship among the combined services and a satisfaction level of the user increased by combining the services.

Another method of dynamically recommending a combined service calculates the degree of complementarity between combined services and recommends a combined service having a high degree of complementarity depending on a situation of a user. However, this dynamic combined service recommendation method encounters problems in that since a degree of complementarity of a combined service is calculated based on demand variability of other combined services with respect to the increase in the price of one service included in the combined service, a demand function for the combined services is needed, and that since a large amount of price data and demand variability data are needed in order to determine a demand function for each service, it is difficult to dynamically recommend a combined service according to the situation of a user varying in real-time. Meanwhile, still another conventional dynamic combined service recommendation method merely discloses a concept of recommending a service combination using the degree of complementarity between the combined services, and hardly teaches a technique of correctly determining a situation of a user or a technique of calculating the degree of complementarity of the combined service in real-time.

### DISCLOSURE OF INVENTION

### Technical Problem

The present invention has been made to solve the above-mentioned problems associated with the combined service recommendation method according to the prior art, and it is an object of the present invention to provide a system of recommending a combined service to a user considering information on a situation of the user, among a plurality of services provided in a ubiquitous computing environment.

Another object of the present invention is to provide a system of recommending a combined service most efficient to a situation of a user considering the degree of complementarity between a plurality of services provided in a ubiquitous computing environment.

Still another object of the present invention is to provide a system for recommending a combined service, in which a degree of complementarity can be calculated considering a satisfaction level calculated by the service combination, profits obtained from the service combination and a loss incurred by the service combination, thereby increasing utilitzation of service combinations and reflect preference of a user.

Yet another object of the present invention is to provide a system for recommending a combined service, which determines whether or not a user is satisfied with only individual services in the first stage and recommends a service combination in the second stage if the user is not satisfied with the individual services.

### Technical Solution

To achieve the above objects, in one aspect, the present invention provides a combined service recommendation system including: a user information management agent for creating or storing static information, dynamic information, extended static information and extended dynamic information on a user; a service selection agent for selecting an individual service having the highest service index increase value among individual services provided to users having situation information similar to that of a target user from a case database based on a result of comparing a service index of the targer user with a target service index, or selecting a combined service having the highest degree of complementarity from the case database based on the degree of complementarity of combined services provided to the users having situation information similar to that of the target user; and an individual service agent for providing the target user with the individual service selected by the service selection agent or individual services configuring the combined service and managing the provided services, wherein the degree of complementarity of the combined service is calculated considering a service index increase value of the target user caused by the service combination, profits obtained from the service combination and loss of cost required for the service combination.

The user information management agent includes: a user information acquisition unit for acquiring the static information and the dynamic information on the target user; an extended information generation unit for generating extended static information and extended dynamic information on the target user by applying the static information and the dynamic information to an information ontology; and the case database for storing the static information, the dynamic information, the extended static information, the extended dynamic information and information on the individual services or combined services used by the users.

The service selection agent includes: a service determination unit for determining a service needed for the target user based on a result of comparison between the situation information of the target user and indexes of a service database; a service index calculation unit for selecting a psychosocial theory model of the determined service and calculating a service index with respect to the determined service for the target user from an independent variable correlation matrix of the selected psychosocial theory model; a service selection determination unit for determining whether to provide an individual service or a combined service according to the situation information of the target user by comparing the calculated service index and the target service index; an individual service selection unit for selecting an individual service having the highest service index increase value among the individual services provided to the users having situation information similar to that of the target user from the case database if it is determined to provide the individual service, and determining whether or not the service index of the target user satisfies the target service index when the selected individual service is provided; and a combined service selection unit for calculating the degree of complementarity of the combined services provided to the users having situation information similar to that of the target user from the case database and selecting a combined service having the highest degree of complementarity if the service index of the target user does not satisfy the target service index when the selected individual service is provided to the target user.

Here, the degree of complementarity of the combined service is calculated by the equation shown below:

$$CI = \frac{f ( {s}_{1} , {s}_{2} ) + f ( 0 , 0 )}{f ( {s}_{1} , 0 ) + f ( 0 , {s}_{2} )}$$

wherein, f(s₁, s₂) is a satisfaction level when both services included in a combined service (s₁, s₂) are provided, f(s₁, 0) is a satisfaction level when either s₁ of the services included in the combined service (s₁, s₂) is provided, f(0, s₂) is a satisfaction level when either s₂ of the services included in the combined service (s₁, s₂) is provided, and f(0, 0) is a satisfaction level when neither of the services included in the combined service (s₁, s₂) is provided.

In another aspect, the present invention provides a combined service recommendation method including the steps of: determining a service needed for a target user based on situation information on the target user and calculating a service index with respect to the determined service for the target user from a psychosocial theory model of the determined service; comparing the service index of the target user with a target service index; selecting an individual service having the highest service index increase value among the individual services used by the users having situation information similar to the situation information on the target user from the case database if the service index of the target user is smaller than the target service index; selecting a combined service having the highest degree of complementarity among combined services used by the users having situation information similar to the situation information on the target user from the case database if the service index of the target user does not exceed the target service index when the individual service selected based on the service index increase value of the selected individual service is provided; and recommending the selected combined service to the target user, wherein the degree of complementarity of the combined service is calculated considering the service index increase value of the target user caused by the service combination, profits obtained from the service combination and loss of cost required for the service combination.

Here, the step of calculating the service index of the target user and the target service index includes the steps of: generating extended static information and extended dynamic information on the target user by applying static information on the target user stored in the case database and acquired dynamic information on the target user to an information ontology; determining a service needed for the target user by comparing the static and dynamic information on the target user and the extended static and dynamic information on the target user with indexes of a service database; selecting a psychosocial theory model associated with the determined service and generating an independent variable correlation matrix of the selected psychosocial theory model; and calculating a service index of the service determined for the targer user based on the generated independent variable correlation matrix and values of independent variables evaluated by the target user.

### Advantageous Effects

The method and system for recommending a combined service in accordance with the present invention have various advantageous effects described below compared with a conventional method of recommending a combined service.

First, the method and system for recommending a combined service in accordance with the present invention can dynamically recommend a combined service depending on a user situation varying in real-time, in which information on the user situation is determined, and the combined service is recommended depending on the determined user situation information.

Second, the method and system for recommending a combined service in accordance with the present invention recommend a combined service considering service preference of a user, in which can the service combination is determined using a degree of complementarity which reflects an amount of increase in a service index of a user for the combined service, profits obtained from the service combination and a loss of cost required for the service combination.

Third, the method and system for recommending a combined service in accordance with the present invention may increase the possibility of a user using the combined service by calculating the degree of complementarity among a plurality of services provided in a ubiquitous computing environment and determining the service combination.

### BRIEF DESCRIPTION OF THE DRAWINGS

FIG. 1 is a functional block diagram showing a combined service recommendation system according to the present invention.

FIG. 2 is a functional block diagram showing a user information management agent according to the present invention.

FIG. 3 is a view showing an example of extended user information created by applying acquired static or dynamic user information to an information ontology.

FIG. 4 is a functional block diagram showing a service selection agent 400 according to the present invention.

FIG. 5 is a flowchart illustrating a combined service recommendation method according to the present invention.

FIG. 6 is a flowchart illustrating a method of calculating a service index of a target user according to the present invention.

FIG. 7 is a flowchart illustrating a method of selecting an individual service according to the present invention.

FIG. 8 is a flowchart illustrating a method of selecting a combined service according to the present invention.

FIG. 9 is a flowchart illustrating a method of providing a recommended service according to the present invention.

### BEST MODE FOR CARRYING OUT THE INVENTION

Hereinafter, a method and system for recommending a combined service according to the present invention will be described in more detail with reference to the accompanying drawings.

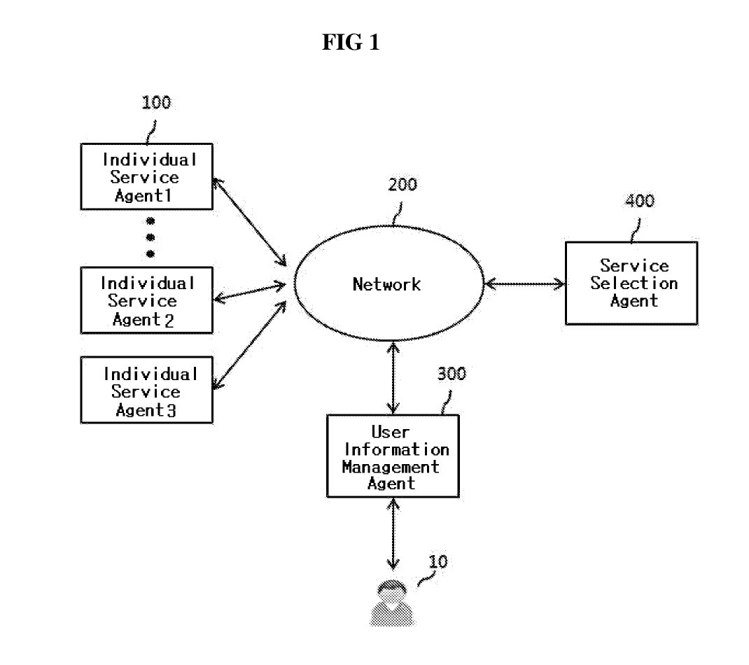

FIG. 1 is a functional block diagram showing a combined service recommendation system according to the present invention.

Referring to FIG. 1, the combined service recommendation system according to an embodiment of the present invention includes a plurality of individual service agents 100 connected to a network 200 and providing individual services, a user information management agent 300 for managing user situation information such as static information, dynamic information, extended static information and extended dynamic information, and a service selection agent 400 for determining a service type needed for a target user based on situation information on the target user and selecting an individual service or a combined service to be recommended to the target user according to the determined service type from a case database based on a service usage history of users having situation information similar to that of the target user.

Meanwhile, the user information management agent 300 acquires the static or dynamic user information from a user terminal (not shown) possessed by the user 10. The static or dynamic user information is inputted by the user 10 himself or herself through the user terminal or determined through dynamic information detecting sensors, such as a position sensor, a biosensor, a motion sensor, a illuminance sensor or the like, attached to the user terminal. Here, the static user information is user situation information that is not frequently changed such as a name, a sex, an address, an age and the like of the user, and the dynamic user information is user situation information that is continuously changed such as a current position, a time, an emotion and the like of the user. The extended static and dynamic information is user situation information created by applying the static and dynamic user information to an information ontology.

Preferably, the user terminal is connected to the network 200. The static or dynamic user information inputted by the user himself or herself through the user terminal and stored in the user terminal is transmitted to the user information management agent 300 through the network 200, or the dynamic user information is determined through the dynamic information detecting sensors of the user terminal and transmitted to the user information management agent 300 through the network 200.

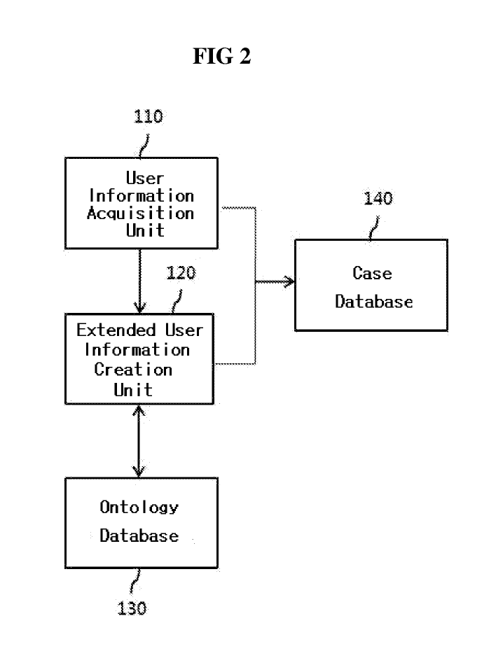

FIG. 2 is a functional block diagram showing a user information management agent according to the present invention.

The user information management agent will be described hereinafter further detail with reference to FIGS. 1 and 2. A user information acquisition unit 110 acquires static or dynamic user information through the network 200 or directly from the user terminal. An extended user information creation unit 120 creates extended static or dynamic information by applying the acquired static or dynamic user information to the information ontology of an ontology database 130. Here, the information ontology is an ontology used to extend meaning information that can be created from each word configuring the static or dynamic user information. For example, the information ontology includes time-related ontology such as day/night, AM/PM, day, month, season, year, vacation, holiday, celebration day and the like, location-related ontology such as country, city, mountain, beach, amusement part and the like, and situation-related ontology such as travel, business, going to work, leaving work, business trip, honeymoon trip, date and the like.

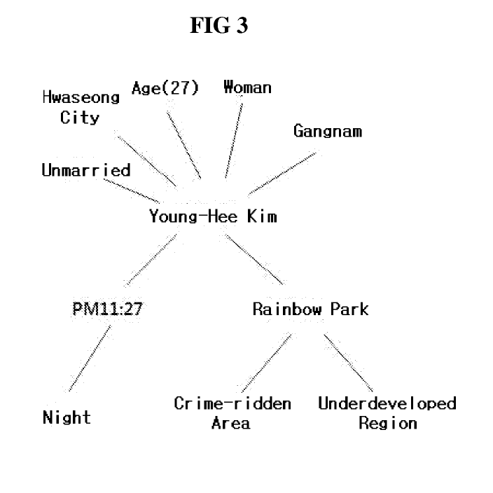

FIG. 3 is a view showing an example of extended user information created by applying acquired static or dynamic user information to an information ontology. As shown in FIG. 3, the system acquires static user information including that a user named Young-hee Kim is an unmarried woman aged 27, working at a company in Gangnam and living in Hwaseong city, and acquires dynamic information including that the current position of the user is near the Rainbow park in the residential area of the user and current time is 11:15 PM. Extended dynamic information such as a late night is obtained by applying time information such as 11:15 PM to the time-related ontology, or extended dynamic information such as a crime-ridden area or an underdeveloped region is obtained by applying location information such as Hwaseong city or Rainbow park to the location-related ontology, or extended static information such as a young unmarried woman is obtained by applying static information such as age of 27, unmarried and woman to an age ontology or a sex ontology.

Referring to FIGS. 1 and 2 again, the static and dynamic user information acquired by the user information acquisition unit 110 and the extended static and dynamic user information created by the extended user information creation unit 120 are stored in the case database 140. In addition, information such as details of individual services or combined services used by users, service index increase values calculated when the individual services or the combined services are used, and sensitivity to time-delay incurred by combining services is stored in the case database 140. Preferably, a value of increase in a service index with respect to an individual service or a combined service is stored as an average of service index increase values evaluated by a plurality of users.

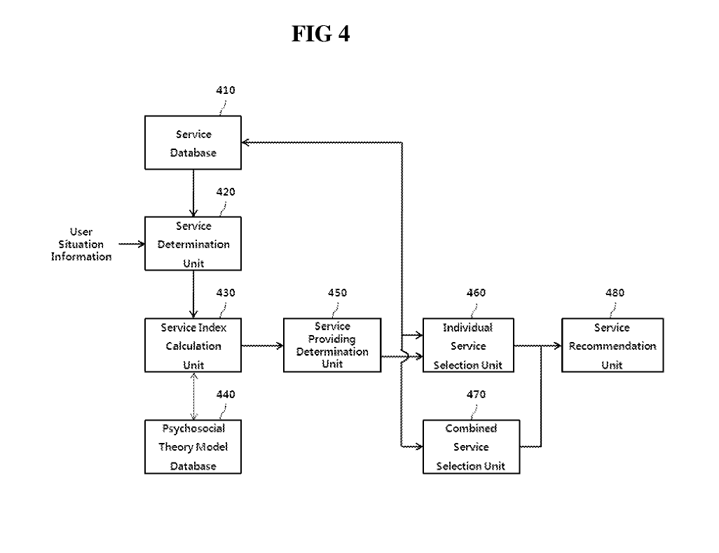

FIG. 4 is a functional block diagram showing a service selection agent 400 according to the present invention.

The service selection agent 400 will be described hereinafter in further detail with reference to FIGS. 1 and 4. A service determination unit 420 receives situation information on a target user from the user information management agent 300 and determines a service needed for the target user from the target user situation information by comparing the received target user situation information with keywords of the services stored in a service database 410. Preferably, service items are classified in the service database 410 according to a service type, and service keywords related to a corresponding service item are stored in the service database 410. For example, a safety/security service, a homecare service, a health service, a leisure service and the like are classified as service items in the service database 410, and service keywords, such as young girl, woman, child, crime-ridden area, night, sexual crime, underdeveloped region and the like, are matched to the safety/security service. In addition, details of each individual service provided by a plurality of individual service agents 100 are stored in the service database 410.

A service index calculation unit 430 selects a psychosocial theory model associated with the determined service from a psychosocial theory model database 440, creates an independent variable correlation matrix of the selected psychosocial theory model, and calculates a service index of the determined service evaluated by the target user. Here, the psychosocial theory model is a model used for calculating a service index of a target user with respect to the determined service based on the situation information on the target user. For example, when a service needed for the target user is the safety/security service, it is a questionnaire model created based on the situation information on the target user, with respect to a safety/security infrastructure level of a region where the target user is positioned, a safety level of the safety/security infrastructure felt by the target user, i.e., a woman in twenties, and a level of worrying about a crime felt by the target user.

A service providing determination unit 450 determines whether an individual service or a combined service will be provided to the target user by comparing the calculated service index with a target service index. If the calculated service index does not satisfy the target service index and service providing determination unit 450 determines to provide an individual service or a combined service, an individual service selection unit 460 searches for users having situation information similar to that of the target user from the case database and selects an individual service whose service index increase value, i.e., a satisfaction level, is increased high among individual services used by the searched users. The individual service selection unit 460 determines whether or not the service index of the target user satisfies the target service index based on the service index increase value of the selected individual service although only the selected individual service is provided to the target user.

If it is determined that the service index of the target user cannot be increased as high as the target service index only with the selected individual service based on a result of the determination of the individual service selection unit 460, a combined service selection unit 470 calculates the degree of complementarity of combined services configured of individual services provided to the users having situation information similar to that of the target user from the case database and selects a combined service having a high degree of complementarity.

A service recommendation unit 480 recommends an individual service selected by the individual service selection unit 460 or a combined service selected by the combined service selection unit 470 to the target user, and if a command for selecting an individual service or a combined service is received from the target user, the service recommendation unit 480 requests to provide an individual service to the target user from the individual service agent which provides individual services or the individual service agent which provides individual services for configuring the combined service. Meanwhile, when the target user receives information on the service index increase of the individual service or the combined service after using the individual service or the combined service, the service recommendation unit 480 updates the service index increase value of the recommended individual service or combined service stored in the case database 410.

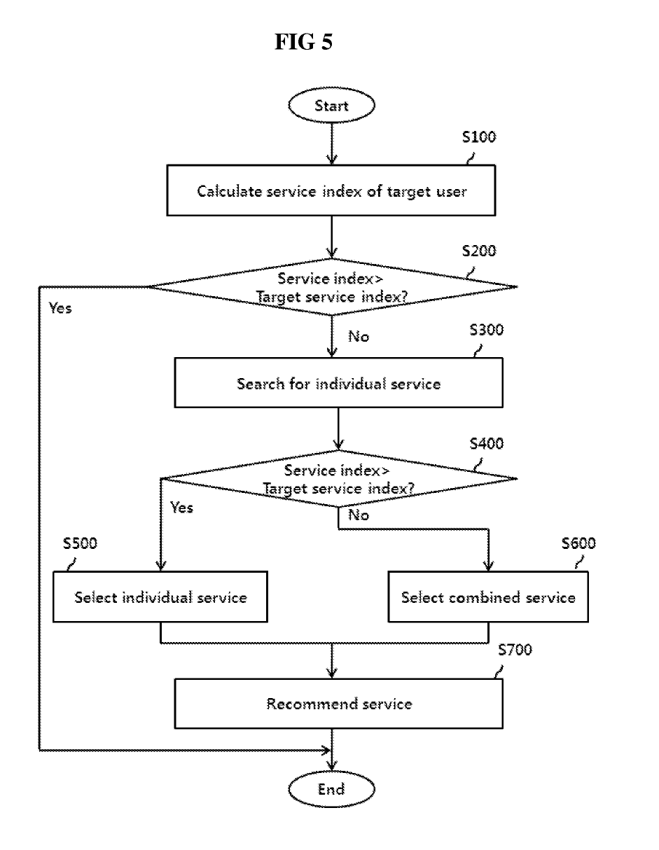

FIG. 5 is a flowchart illustrating a combined service recommendation method according to the present invention.

The combined service recommendation method will be described hereinafter in further detail with reference to FIG. 5, a service needed for a target user is determined based on situation information on the target user, and a service index of the target user with respect to the determined service is calculated (S100). It is determined whether or not the calculated service index of the target user satisfies a target service index (S200). The service index is an index expressing the current satisfaction level of the service determined for the target user, and the target service index is a service index expressing satisfaction of the target user for the determined service. Preferably, the target service index can be initially set by the target user.

When the service index of the target user is smaller than the target service index, an individual service having a high service index increase value is selected from the case database among individual services used by users having situation information similar to the situation information on the target user (S300). It is determined whether or not the service index of the target user satisfies the target service index only by providing a individual service selected based on the service index increase value of the selected individual service (S400), and when the service index of the target user does not exceed the target service index with only the selected individual service, a service combination having a high degree of complementarity, among the combined services used by the users having situation information similar to the situation information on the target user, is selected from the case database (S600). However, when the service index of the target user satisfies the target service index only with the selected individual service, the selected individual service is determines as an individual service to be recommended to the target user (S500). Then, the selected individual service or the combined service is recommended to the target user (S700).

Here, a similarity s₁(i, t) between the situation information on a user i stored in the case database and the situation information on the target user t is calculated by Equation 1 shown below:

s₁(i,t)=Σ(w₁ₖ·d₁(cᵢₖ,cₜₖ)) [Equation 1]

wherein w₁ₖ denotes a weighting factor for each item of the situation information, and d₁(cᵢₖ, cₜₖ) denotes a similarity between the target user and the user for each item of the situation information. For example, when age and sex are stored in the case database as static information and current location and time are stored as dynamic information, w₁ₖ denotes weighting factors of age, sex, location and time, and d₁(cᵢₖ, cₜₖ) denotes similarities between age, sex, location and time of a user stored in the case database and those of a target user. The similarity is a value expressing how close the situation information on the users to the situation information on the target user, the more similar the situation information on a user to the situation information on the target user, the smaller the value of the similarity.

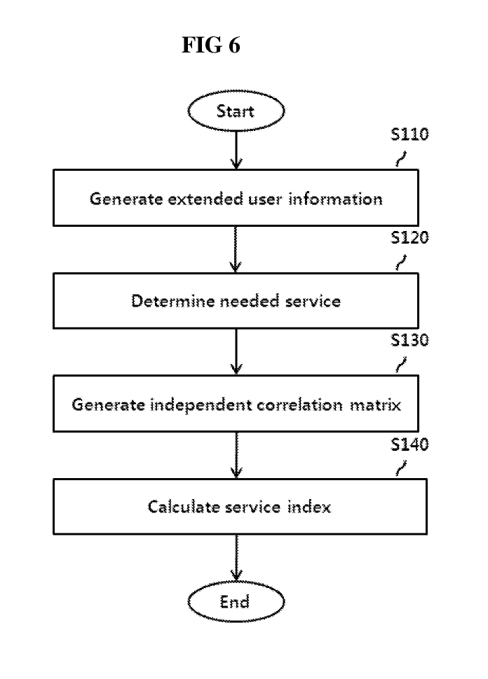

FIG. 6 is a flowchart illustrating a method of calculating a service index of a target user according to the present invention.

Referring to FIG. 6, the extended static and dynamic information on the target user is created by applying the static and dynamic information on the target user stored in the case database to an information ontology (S110). A service needed for the target user is determined by comparing the static and dynamic information on the target user and the extended static and dynamic information on the target user with index words stored in the service database (S120). A psychosocial theory model associated with the determined service is selected from the psychosocial theory model database, and an independent variable correlation matrix of the selected psychosocial theory model is created (S130). A service index of the service determined for the target user is calculated based on the created independent variable correlation matrix and an evaluation value of the target user for the independent variable (S140). Preferably, the evaluation value of the target user for the independent variable is inputted by the user through the user terminal.

The independent variable correlation matrix will be described hereinafter in further detail. Independent variables using a service index of a service related to the selected psychosocial theory model as a dependent variable are extracted, and independent variables significant to the target user are filtered from the extracted independent variables by determining significance between the extracted independent variables and the static, dynamic, extended static and extended dynamic information on the target user. The independent variable correlation matrix is generated based on the correlation coefficient among the filtered independent variables.

Here, a correlation coefficient of an independent variable is a coefficient expressing how much a dependent variable and the independent variable are related or how much the independent variables are related, which is a value expressing a relation between the extracted independent variable and the dependent variable, i.e., a service index, or a value expressing a relation among the independent variables. Correlation coefficients of independent variables are previously stored in the psychosocial theory model database. Preferably, the correlation matrix is created by converting the correlation coefficients of the independent variables into a Petri net. The Petri net is invented by Carl Petri of Germany in 1960s, which is a method used as a useful means for modeling various situations. Hereinafter, details thereof will be omitted.

Preferably, the significance between the extracted independent variables and the situation information on the target user is determined based on meta-information of the psychosocial theory model. For example, if independent variables extracted from the psychosocial theory model selected based on the meta-information of the selected psychosocial theory model are independent variables related only to male users, independent variables insignificant to female target users among the independent variables of the selected psychosocial theory model are filtered and deleted.

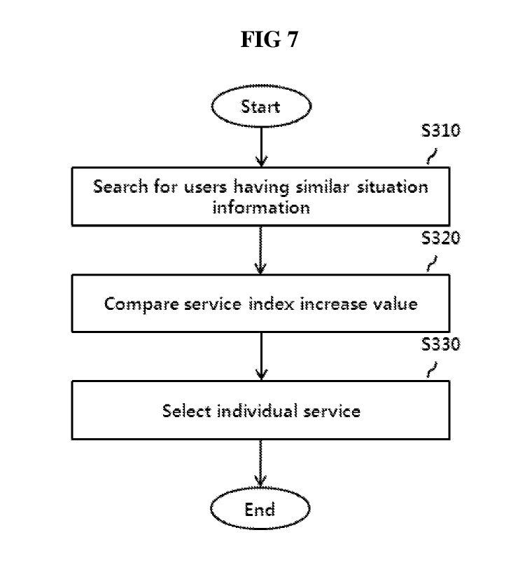

FIG. 7 is a flowchart illustrating a method of selecting an individual service according to the present invention.

Referring to FIG. 7, users having situation information similar to the situation information on the target user are searched from the case database (S310), and service index increase values of the individual services used by the searched users are compared with one another (S320). The situation information on the users or the target user is stored in the case database. In addition, the individual services used by the users in a situation corresponding to the situation information on the user and the service index increase values evaluated by the users after using the individual services are stored in the case database. An individual service having a high service index increase value is selected based on the service index increase values of the individual services used by the searched users S330. If the service index of the target user satisfies the target service index when the selected individual service is provided, the selected individual service is recommended to the target user. Preferably, all the individual services which satisfy the target service index when the selected individual service is provided are recommended to the target user, and the target user may select a desired individual service among the recommended individual services.

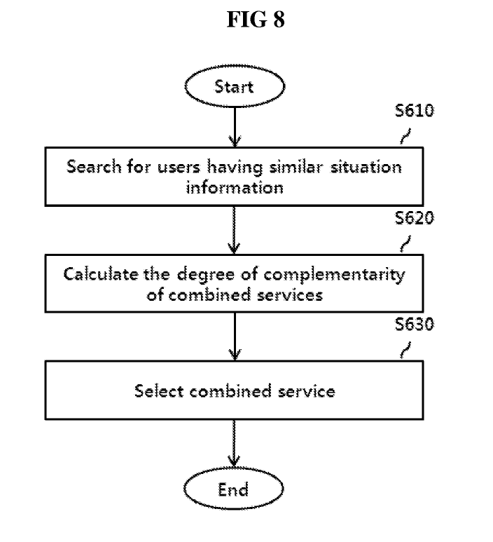

FIG. 8 is a flowchart illustrating a method of selecting a combined service according to the present invention.

Referring to FIG. 8, users having situation information similar to the situation information on the target user are searched from the case database (S610), and the degree of complementarity of combined services used by a plurality of the searched users are calculated (S620). As an example of calculating the degree of complementarity of a combined service, the combined service is configured from a service combination created from individual services used by the searched users and a degree of complementarity of the combined service is calculated, or a degree of complementarity of a combined service is calculated from a combined service used by one searched user. For example, the degree of complementarity is calculated by configuring a combined service (s1, s2) from service s1 used by user A and service s2 used by user B, or the degree of complementarity of a combined service (s1, s2) used by user A is calculated.

A combined service having the highest degree of complementarity among combined services having a degree of complementarity higher than a threshold degree of complementarity is selected based on the calculated degree of complementarity of the combined service (S630). Preferably, a plurality of top service combinations having a degree of complementarity higher than the threshold complementary index can be selected and recommended to the target user based on the calculated degree of complementarity of the combined service.

The degree of complementarity CI of the combined service is calculated by Equation 2 shown below:

$$CI = \frac{f ( {s}_{1} , {s}_{2} ) + f ( 0 , 0 )}{f ( {s}_{1} , 0 ) + f ( 0 , {s}_{2} )} \qquad [ Equation 2 ]$$

wherein f(s₁, s₂) is a satisfaction level when both services included in a combined service (s₁, s₂) are provided, f(s₁, 0) is a satisfaction level when either s₁ of the services included in the combined service (s₁, s₂) is provided, f(0, s₂) is a satisfaction level when either s₂ of the services included in the combined service (s₁, s₂) is provided, and f(0, 0) is a satisfaction level when neither of the services included in the combined service (s₁, s₂) is provided.

f(s₁, s₂) is calculated by Equation 3 shown below:

f(s₁,s₂)=ΔV(s₁,s₂)−TBC+V_{c} [Equation 3]

wherein V(s₁, s₂) is the sum of service index increase values of combined service (s₁, s₂), TBC is a value of a service index converted from total cost required to provide the combined service (s₁, s₂), and Vₜ is a service index when the combined service (s₁, s₂) is not provided. Meanwhile, TBC is the sum of values of service indexes respectively converted from the cost required to provide the combined service (s₁, s₂) and a monetary value of the sensitivity of the target user to the time delay required to search for the combined service. Preferably, the value of the service index converted from the cost required to provide the combined service is previously set, and the monetary value of the sensitivity of the target user to the time delay required to search for the combined service is previously set by the target user.

Preferably, when the target user uses a combination of two individual services (s₁, s₂), a cost discount is applied so that using the combined service is cheaper than independently using the individual services (s₁, s₂). Here, the value of the service index with respect to the cost and information on the cost discount are stored in the service database, and the monetary value of the sensitivity of the target user to the time delay is stored in the case database.

f(s₁, 0), f(0, s₂) and f(0, 0) are calculated by Equations 4 to 6 shown below:

f(s₁,0)=ΔV(s₁)−Cₛ₁+V_{c} [Equation 4]

f(0,s₂)=ΔV(s₂)−Cₛ₂+V_{c} [Equation 5]

f(0,0)=ΔV(s₂)−Cₛ₂+V_{c} [Equation 6]

wherein V(s₁) and V(s₂) are service index increase values of the services (s₁, s₂), and Cₛ₁ and Cₛ₂ are values of service indexes converted from the costs required for providing the services (s₁, s₂).

As is understood from equations 2 to 6, a degree of complementarity of a combined service is calculated considering the service index increase value of the target user obtained from the service combination, profits obtained from the service combination and a loss of cost required for the service combination, and thus the target user can be provided with a satisfactory combined service at a low price, and service providers may expect increase in service sales owing to the combined services.

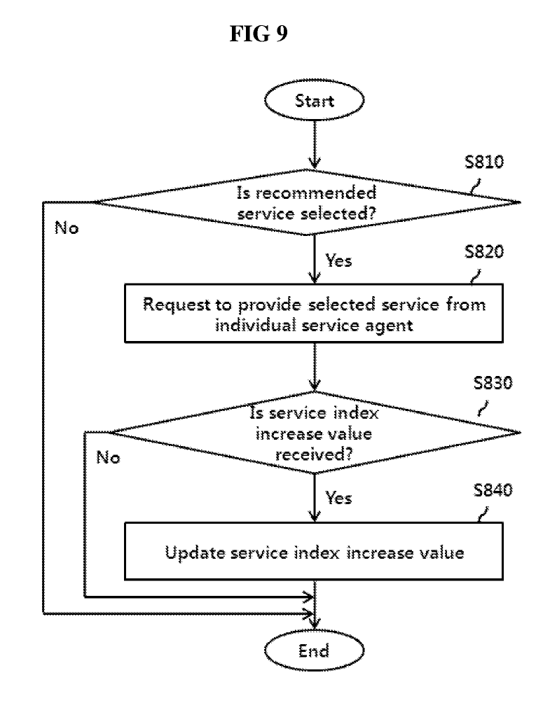

FIG. 9 is a flowchart illustrating a method of providing a recommended service according to the present invention.

Referring to FIG. 9, after an individual service or a combined service is recommended to the target user, it is determined whether or not a command requesting the recommended individual service or the combined service is received from the target user (S810). If the request command is received from the target user, it is requested to provide the service selected by the target user from the individual service agent which provides the recommended service or a plurality of individual service agents which provide individual services for configuring the recommended combined service (S820). After the target user uses the selected individual service or combined service, it is determined whether or not information on the service index increase value with respect to the selected individual service or combined service is received from the target user (S830). Then, the service index increase value with respect to the individual service or the combined service stored in the case database is updated based on the received service index increase value with respect to the individual service or the combined service (S840).

While the present invention has been described in connection with the exemplary embodiments illustrated in the drawings, they are merely illustrative and the invention is not limited to these embodiments. It will be appreciated by a person having an ordinary skill in the art that various equivalent modifications and variations of the embodiments can be made without departing from the spirit and scope of the present invention. Therefore, the true technical scope of the present invention should be defined by the technical spirit of the appended claims.

1. A combined service recommendation system comprising:
a user information management agent for creating or storing static information, dynamic information, extended static information and extended dynamic information on a user;
a service selection agent for selecting an individual service having the highest service index increase value among individual services provided to users having situation information similar to that of a target user from a case database based on a result of comparing a service index of the targer user with a target service index, or selecting a combined service having the highest degree of complementarity from the case database based on the degree of complementarity of combined services provided to the users having situation information similar to that of the target user; and
an individual service agent for providing the target user with the individual service selected by the service selection agent or individual services configuring the combined service and managing the provided services, wherein the degree of complementarity of the combined service is calculated considering a service index increase value of the target user caused by the service combination, profits obtained from the service combination and loss of cost required for the service combination.

2. The combined service recommendation system according to claim 1, wherein the user information management agent comprises:
a user information acquisition unit for acquiring the static information and the dynamic information on the target user;
an extended information generation unit for generating extended static information and extended dynamic information on the target user by applying the static information and the dynamic information to an information ontology; and
the case database for storing the static information, the dynamic information, the extended static information, the extended dynamic information and information on the individual services or combined services used by the users.

3. The combined service recommendation system according to claim 2, wherein the service selection agent comprises:
a service determination unit for determining a service needed for the target user based on a result of comparison between the situation information of the target user and indexes of a service database;
a service index calculation unit for selecting a psychosocial theory model of the determined service and calculating a service index with respect to the determined service for the target user from an independent variable correlation matrix of the selected psychosocial theory model;
a service selection determination unit for determining whether to provide an individual service or a combined service according to the situation information of the target user by comparing the calculated service index and the target service index;
an individual service selection unit for selecting an individual service having the highest service index increase value among the individual services provided to the users having situation information similar to that of the target user from the case database if it is determined to provide the individual service, and determining whether or not the service index of the target user satisfies the target service index when the selected individual service is provided; and
a combined service selection unit for calculating the degree of complementarity of the combined services provided to the users having situation information similar to that of the target user from the case database and selecting a combined service having the highest degree of complementarity if the service index of the target user does not satisfy the target service index when the selected individual service is provided to the target user.

4. The combined service recommendation system according to claim 2, wherein the degree of complementarity of the combined service is calculated by the equation shown below:
$$CI = \frac{f ( {s}_{1} , {s}_{2} ) + f ( 0 , 0 )}{f ( {s}_{1} , 0 ) + f ( 0 , {s}_{2} )}$$
wherein f(s₁, s₂) is a satisfaction level when both services included in a combined service (s₁, s₂) are provided, f(s₁, 0) is a satisfaction level when either s₁ of the services included in the combined service (s₁, s₂) is provided, f(0, s₂) is a satisfaction level when either s₂ of the services included in the combined service (s₁, s₂) is provided, and f(0, 0) is a satisfaction level when neither of the services included in the combined service (s₁, s₂) is provided.

5. A combined service recommendation method comprising the steps of:
determining a service needed for a target user based on situation information on the target user and calculating a service index with respect to the determined service for the target user from a psychosocial theory model of the determined service;
comparing the service index of the target user with a target service index;
selecting an individual service having the highest service index increase value among the individual services used by the users having situation information similar to the situation information on the target user from the case database if the service index of the target user is smaller than the target service index;
selecting a combined service having the highest degree of complementarity among combined services used by the users having situation information similar to the situation information on the target user from the case database if the service index of the target user does not exceed the target service index when the individual service selected based on the service index increase value of the selected individual service is provided; and
recommending the selected combined service to the target user, wherein the degree of complementarity of the combined service is calculated considering the service index increase value of the target user caused by the service combination, profits obtained from the service combination and loss of cost required for the service combination.

6. The combined service recommendation method according to claim 5, wherein the situation information comprises static information, dynamic information, extended static information and extended dynamic information on the target user.

7. The combined service recommendation method according to claim 6, wherein the step of calculating the service index of the target user and the target service index comprises the steps of:
generating extended static information and extended dynamic information on the target user by applying static information on the target user stored in the case database and acquired dynamic information on the target user to an information ontology;
determining a service needed for the target user by comparing the static and dynamic information on the target user and the extended static and dynamic information on the target user with indexes of a service database;
selecting a psychosocial theory model associated with the determined service and generating an independent variable correlation matrix of the selected psychosocial theory model; and
calculating a service index of the service determined for the targer user based on the generated independent variable correlation matrix and values of independent variables evaluated by the target user.

8. The combined service recommendation method according to claim 7, wherein the independent variable correlation matrix is generated by performing the following steps:
extracting independent variables using a service index of a service related to the selected psychosocial theory model as a dependent variable;
filtering independent variables significant to the target user from the extracted independent variables by determining significance between the extracted independent variables and the static, dynamic, extended static and extended dynamic information on the target user; and
generating the independent variable correlation matrix based on the correlation coefficient among the filtered independent variables.

9. The combined service recommendation method according to claim 6, wherein the step of selecting the combined service comprises the steps:
searching users having situation information similar to the situation information on the target user from the case database;
calculating the degree of complementarity of combined services used by the searched users; and
selecting a combined service having the highest degree of complementarity among combined services of the users.

10. The combined service recommendation method according to claim 9, wherein a similarity s₁(i, t) between the situation information on the users i stored in the case database and the situation information on the target user t is calculated by Equation 1 shown below:
s₁(i,t)=Σ(w₁ₖ·d₁(cᵢₖ,cₜₖ)) [Equation 1]
wherein w₁ₖ denotes a weighting factor for each item of the situation information, and d₁(cᵢₖ, cₜₖ) denotes a similarity between the target user and the users for each item of the situation information.

11. The combined service recommendation method according to claim 9, wherein the degree of complementarity CI of the combined service is calculated by Equation 2 shown below:
$$CI = \frac{f ( {s}_{1} , {s}_{2} ) + f ( 0 , 0 )}{f ( {s}_{1} , 0 ) + f ( 0 , {s}_{2} )} \qquad [ Equation 2 ]$$
wherein f(s₁, s₂) is a satisfaction level when both services included in a combined service (s₁, s₂) are provided, f(s₁, 0) is a satisfaction level when either s₁ of the services included in the combined service (s₁, s₂) is provided, f(0, s₂) is a satisfaction level when either s₂ of the services included in the combined service (s₁, s₂) is provided, and f(0, 0) is a satisfaction level when neither of the services included in the combined service (s₁, s₂) is provided.
